(19) United States
(12) Patent Application Publication
(10) Pub. No.: US 2012/0326492 A1
(43) Pub. Date: Dec. 27, 2012

(54) BRAKE SYSTEM HAVING A PRESSURE MODULATION CYLINDER

(76) Inventor: Jochen Mayer, Giengen (DE)

(21) Appl. No.: 13/517,037

(22) PCT Filed: Oct. 25, 2010
(86) PCT No.: PCT/EP2010/066039

§ 371 Date: Sep. 12, 2012

(30) Foreign Application Priority Data
Dec. 23, 2009 (DE) 102009055244.8

(51) Int. Cl. B60T 13/58; B60T 13/12

(52) U.S. Cl. 303/9.72; 188/152; 303/6.01

(57) ABSTRACT

A brake device for motor vehicles has a master brake cylinder for generating brake pressure at at least one wheel brake. To be able to vary the brake pressure at particular wheel brakes individually, a pressure modulation cylinder having a plurality of chambers is provided between the master brake cylinder and the wheel brakes, a first chamber being connected via a first fluid line to the master brake cylinder, and a second chamber being connected via a second fluid line to the at least one wheel brake. The first and second chambers are connected to each other via a fluid line in which a valve is situated.

### BACKGROUND OF THE INVENTION

1. Field of the Invention

The present invention relates to a brake system having at least one pressure modulation cylinder.

2. Description of the Related Art

Modern vehicles frequently have a brake system which is set up for an ABS control or a vehicle dynamics control such as ESP, for example. Such brake systems include a number of valves, such as inlet and outlet valves, which are actuated automatically by a control device in order to build up or reduce brake pressure at the wheel brakes. Moreover, a hydraulic pump is usually provided, with the aid of which brake pressure can be built up at the wheel brakes automatically.

From published German patent application document DE 10 2005 055 751 A1, a hydraulic brake system is known which has a pressure modulation cylinder instead of a hydraulic pump, with whose aid the brake pressure is able to be actively built up or reduced at the wheel brakes. However, this brake system requires a travel simulator, which must be switched off when the electrical energy supply fails. Moreover, a low-pressure solenoid valve is provided, which is meant to prevent the aspiration of brake fluid at low pressures (“post-sniffing”). The brake system described here thus is relatively complex and cost-intensive.

### BRIEF SUMMARY OF THE INVENTION

Therefore, it is an object of the present invention to construct a brake system having a pressure modulation cylinder, which has a considerably simpler design and which allows the brake pressure to be varied automatically.

According to the present invention, a brake device is provided, in which a pressure modulation cylinder having a plurality of chambers is situated between the master brake cylinder and the wheel brakes. Via a first fluid line, a first chamber of the pressure modulation cylinder is connected to the master brake cylinder, and a second chamber is connected to at least one wheel brake via a second fluid line. Furthermore, the first and second chambers of the pressure modulation cylinder are also connected to each other via a fluid line in which a valve is situated. This structure is especially simple and allows the brake system to be operated both in a standard mode, in which the driver generates brake pressure in the conventional manner by actuating a foot brake pedal, and in an automatic mode, in which, for example, an ABS control or an automatic pressure generation is able to be carried out.

Each wheel brake is preferably assigned a separate, combined inlet/outlet valve, which assumes the dual function of a conventional inlet and outlet valve. It is therefore no longer necessary to provide separate inlet and outlet valves.

The combined inlet/outlet valve according to the present invention is preferably provided between one of the wheel brakes and the aforementioned valve situated in the fluid line that connects the two chambers of the pressure modulation cylinder.

The valve connected between the two chambers of the pressure modulation cylinder preferably is connected via a fluid line to the master brake cylinder, and via an additional fluid line, to one or more inlet/outlet valves.

The brake pressure generated by the pressure modulation cylinder is preferably measured by means of a wheel pressure sensor. The wheel pressure sensor is preferably disposed between the wheel-side output of the pressure modulation cylinder and an inlet/outlet valve.

The pressure modulation cylinder according to the present invention may have one or more chambers. The chambers are separated from each other, preferably by a displaceable piston. The piston is preferably driven by a piston drive such as an electric motor, for instance.

The chambers of the pressure modulation cylinder preferably have an input that simultaneously functions as output.

In the case of a brake device having a plurality of brake circuits, it is preferred if each brake circuit includes a separate pressure modulation cylinder. Preferably, precisely one pressure modulation cylinder per brake circuit is provided.

For a brake device having a plurality of brake circuits, a plurality of pressure modulation cylinders may be driven by a single drive. According to one preferred specific development, only a single pressure modulation cylinder drive is provided there in the entire brake system. The movement of the individual pressure modulation cylinders then preferably takes place in synchronous manner. As an alternative, it is also possible to provide different drives for the individual pressure modulation cylinders.

The valves of the brake device according to the present invention are preferably implemented as 2/2-way valves. For example, they may be open when no current is flowing.

The brake pressure prevailing at a wheel brake is preferably measured and stored when the associated inlet/outlet valve is closed. As a consequence, the brake pressure applied at the wheel brake is known and able to be utilized at a later time for the control of the pressure modulation cylinder, for instance.

According to a preferred specific development of the present invention, prior to opening an inlet/outlet valve, the piston of the pressure modulation cylinder is brought into a position in which the pressure drop at the affected inlet/outlet valve is approximately 0 bar. This avoids a pressure equalization shock when opening the inlet/outlet valve.

### BRIEF DESCRIPTION OF THE DRAWINGS

FIG. 1 shows a one-circuit brake system to explain the basic function of the brake device according to the present invention.

FIG. 2 shows an exemplary embodiment of a two-circuit brake system.

### DETAILED DESCRIPTION OF THE INVENTION

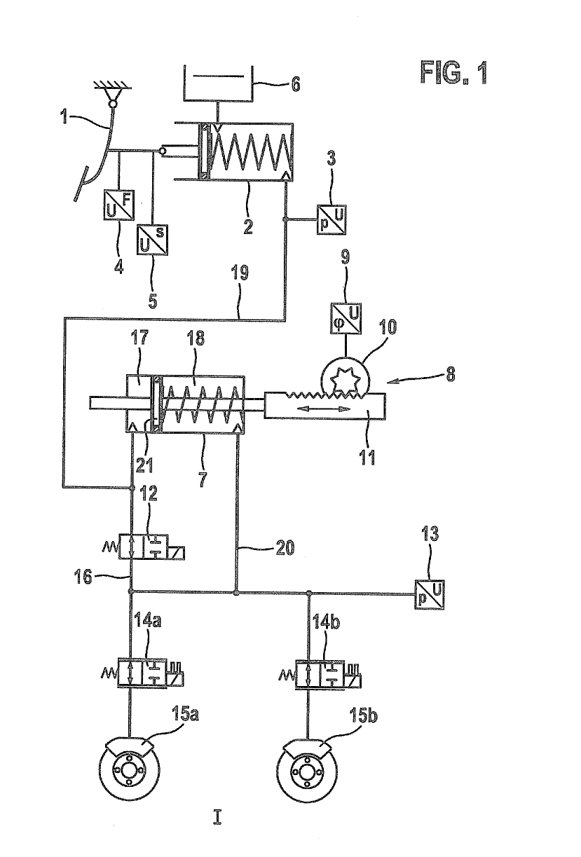

FIG. 1 shows a preferred exemplary embodiment of a hydraulic brake system, in which only a single brake circuit is illustrated for the sake of clarity. The illustrated brake system includes a brake pedal 1, which acts on a master brake cylinder 2. A brake fluid container 6 is situated on master brake cylinder 2. Force F exerted at brake pedal 1, or pedal travel s is measurable with the aid of a force sensor 4 or travel sensor 5 respectively. The brake pressure generated by the driver is measured in the conventional manner, with the aid of a so-called admission-pressure sensor 3. The output of master brake cylinder 2 is connected to pressure modulation cylinder 7 via a hydraulic line 19.

Pressure modulation cylinder 7 in the case at hand has two chambers 17, 18, that is to say, a first chamber 17 and a second chamber 18, which are separated from each other by a displaceable piston 21. Piston 21 is driven by a piston drive 8, which in this example includes an electric motor 10 having a pinion situated atop its shaft, and a toothed rack 11. The exact position of pinion drive 10 is able to be measured with the aid of a position sensor 9. By driving toothed rack 11 to the left or right (see arrow), the volumes of the two chambers 17, 18 are able to be varied and brake pressure be reduced or generated at wheel brakes 15a, 15b in this manner.

The two chambers 17, 18 of pressure modulation cylinder 7 have a separate inlet, which also acts as outlet. The inlet of first chamber 17 is connected to the master brake cylinder, and, via a further fluid line 16, to the two wheel brakes 15a, 15b. An overflow valve 12 is disposed in this fluid line 16, downstream from the branch-off to wheel brakes 15a, 15b.

Each wheel brake 15a, 15b includes an associated combined inlet/outlet valve 14a, 14b, which is situated in a separate fluid line in each case. The two valves 14a, 14b simultaneously assume the function of a conventional inlet and outlet valve. Valves 14a and 14b are open in the currentless state (normally open).

The inlet of second chamber 18 of pressure modulation cylinder 7 is connected via an additional fluid line 20 to the two inlet/outlet valves 14a, 14b. The two chambers 17, 18 are connected to each other via fluid line 16, in which overflow valve 12 is disposed, and fluid line 20. Thus, a volume compensation is able to take place between the two chambers 17, 18 of pressure modulation cylinder 7, via overflow valve 12.

In a conventional service brake operation by actuating the foot pedal, the braking intention of the driver is detected via sensors 4, 5 and/or 3. Overflow valve 12 is closed in this operating mode. The pressure generated by the driver, which pressure also prevails in first chamber 17 of pressure modulation cylinder 7, is amplified by a displacement of piston drive 8 (to the right), so that the pressure prevailing in second chamber 18 and wheel brakes 15a and 15b is greater than the pressure in first chamber 17.

In contrast to the afore-described normal operation, overflow valve 12 is opened in a failure of piston drive 8. In this case, the pressure generated by master brake cylinder 2 is acting on both wheel brakes 15a, 15b via fluid lines 19 and 16, overflow valve 12, and inlet/outlet valves 14a, 14b. The driver-generated pressure is not amplified in this case.

In driving situations in which the brake pressure at wheel brakes 15a, 15b is to be increased automatically (with or without simultaneous actuation of foot brake pedal 1), piston drive 8 moves piston 21 to the right. Overflow valve 12 is closed in this state. The movement of piston 1 toward the right causes the hydraulic fluid to be pushed out of second chamber 18 in the direction of wheel brakes 15a, 15b, so that brake pressure is built up there. First chamber 17 aspirates hydraulic fluid from master brake cylinder 2 via fluid line 19.

For a reduction of brake pressure at wheel brakes 15a, 15b, the piston is moved in the opposite direction, in this case, to the left.

If brake pressure is to be reduced at only one of the wheel brakes, such as 15b, combined inlet/outlet valve 14a of other wheel brake 15a is closed. Prior to this, the brake pressure is also measured with the aid of a wheel brake pressure sensor 13, and then stored. Next, piston 21 is moved to the left, so that the brake pressure at brake 15b is reduced. The brake pressure at brake 15a is enclosed and therefore remains constant. As soon as pressure modulation cylinder 7 is situated in the desired position, the associated inlet/outlet valve (in the present example, 14b) of wheel brake 15b is closed.

If the brake pressure of wheel brake 15a is then to be reduced as well, the following is to be considered. Once the brake pressure at wheel brake 15b has been reduced, the brake pressure prevailing in fluid line 20 is lower than that in wheel brake 15a. In order to prevent a pressure compensation shock when opening valve 14a, prior to opening valve 14a piston 21 is first moved into a position in which the brake pressure in fluid line 20 (at the high-pressure-side inlet of valve 14a) is approximately equal to the brake pressure of wheel brake 15a. As soon as piston 21 has reached the desired position, inlet/outlet valve 14a is opened. By moving piston 21 to the left, it is now possible again to reduce brake pressure at wheel brake 14a. Once a desired target pressure has been attained, the brake pressure at wheel brake 15a is able to be built up or reduced again.

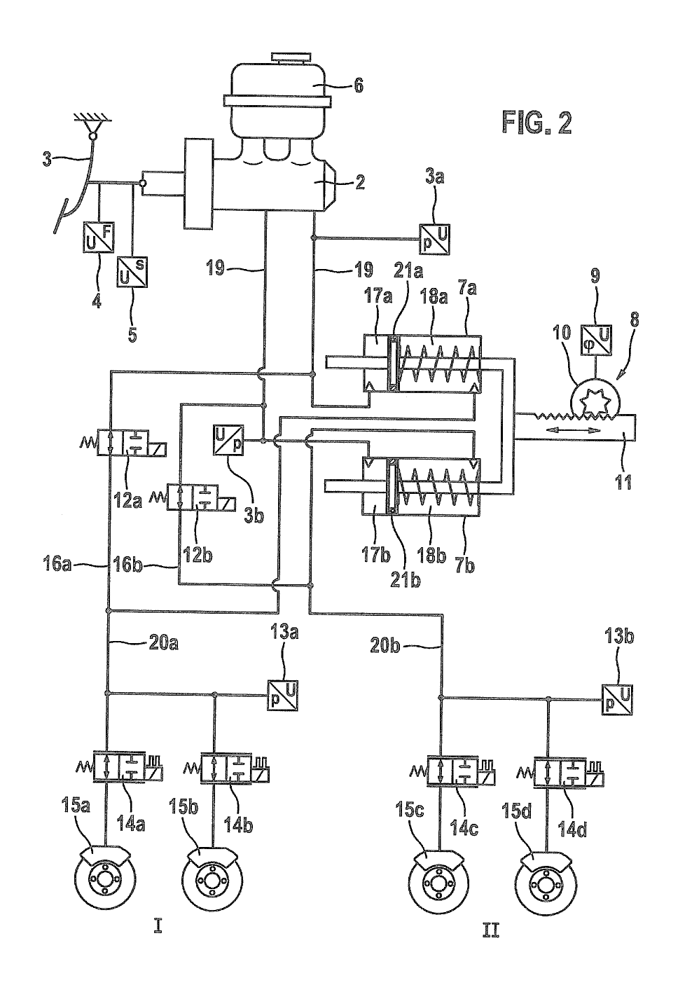

FIG. 2 shows a brake system which basically has the same design as the system of FIG. 1; in contrast to FIG. 1, however, it includes two brake circuits I and II, which are connected to master brake cylinder 2 in parallel. The two brake circuits I and II are identical in their structure and include the same elements as shown in FIG. 1. That is to say, there are two pressure modulation cylinders 7a, 7b, two overflow valves 12a, 12b, two wheel brakes 15a, 15b, and 15c, 15d per brake circuit, and a total of four inlet/outlet valves 14a, 14b, 14c, and 14d, etc.

In this specific development, however, only a single piston drive 8 is provided, which drives the two pistons 21a, 21b of pressure modulation cylinders 7a, 7b in synchronous manner. In order to generate the brake pressure individually at a particular wheel brake, such as 15c, for example, associated inlet/outlet valve 14c is opened (provided it is not already open), and the remaining inlet/outlet valves 14a, 14b, 14d are closed. The two pistons 21a, 21b are then moved to the right by piston drive 8. Piston 21b provided for brake circuit II thus builds up pressure at wheel brake 15c. Associated overflow valve 12b is closed in this case. On the other hand, overflow valve 12a remains open, so that the hydraulic fluid flowing out of second chamber 18a is able to flow in a circle back into first chamber 17a. As soon as the desired target pressure is reached at wheel brake 15c, associated inlet/outlet valve 14c is closed. The pressure enclosed in wheel brake 15c is stored again.

In order to reduce the brake pressure at a specific wheel brake, e.g., 15b, individually, pistons 21a, 21b are preferably moved into a position in which the pressure dropping at the associated inlet/outlet valve is essentially equal to 0 bar. As soon as pistons 21a, 21b assume the desired position, valve 14b is opened. The other valves 14a, 14c and 14d are closed or remain closed. The brake pressure prevailing at wheel brake 15b is now able to be reduced to a desired value. In so doing, the wheel brake pressure is monitored continuously with the aid of wheel brake pressure sensor 13a. Associated overflow valve 12a is closed during the pressure reduction. In contrast, overflow valve 12b of other brake circuit II is open in order to allow pressure compensation between the two chambers 17b, 18b of second pressure modulation cylinder 7b.

Once a desired target pressure has been achieved, the pressure at one or at a plurality of the other wheel brake(s) 15a, 15c or 15d is able to be increased or reduced in a similar manner.

1-10. (canceled)

11. A brake device for motor vehicle, comprising:
a master brake cylinder for generating brake pressure at at least one wheel brake of the vehicle; and
a pressure modulation cylinder having a plurality of chambers, wherein the pressure modulation cylinder is provided between the master brake cylinder and the at least one wheel brake, a first chamber of the pressure modulation cylinder being connected via a first fluid line to the master brake cylinder, and a second chamber of the pressure modulation cylinder being connected via a second fluid line to the at least one wheel brake, and wherein the first and second chambers are connected to each other via a connecting valve.

12. The brake device as recited in claim 11, wherein each wheel brake of the vehicle is assigned a separate single inlet/outlet valve which simultaneously assumes dual functions of an inlet valve and an outlet valve.

13. The brake device as recited in claim 12, wherein each inlet/outlet valve is situated between the connecting valve and the associated wheel brake.

14. The brake device as recited in claim 12, further comprising:
a wheel pressure sensor which measures the pressure generated at the at least one wheel brake by the pressure modulation cylinder.

15. The brake device as recited in claim 12, wherein the first and second chambers are separated from each other by a displaceable piston.

16. The brake device as recited in claim 15, wherein the piston is driven by a piston drive.

17. The brake device as recited in claim 12, wherein at least two brake circuits are provided, and wherein a separate pressure modulation cylinder is provided for each brake circuit has.

18. The brake device as recited in claim 17, wherein the two pressure modulation cylinders are driven in synchronous manner by a single drive.

19. The brake device as recited in claim 15, wherein the connecting valve is open when no current is flowing.

20. The brake device as recited in claim 19, wherein the connecting valve is a 2/2-way valve.
